(19) United States
(12) Patent Application Publication
(10) Pub. No.: US 2024/0119300 A1
(43) Pub. Date: Apr. 11, 2024

(54) CONFIGURING A REINFORCEMENT LEARNING AGENT BASED ON RELATIVE FEATURE CONTRIBUTION

(71) Applicant: Telefonaktiebolaget LM Ericsson (publ), Stockholm (SE)

(72) Inventors: Ahmad Ishtar TERRA, Sundbyberg (SE); Rafia INAM, Västerås (SE); Alberto HATA, CAMPINAS SP (BR); Ajay KATTEPUR, BANGALORE (IN); Hassam RIAZ, Järfälla (SE)

(21) Appl. No.: 18/275,580

(22) PCT Filed: Feb. 5, 2021
(86) PCT No.: PCT/EP2021/052852

§ 371 Date: Aug. 2, 2023

(51) Int. Cl. G06N 3/092

(52) U.S. Cl. CPC G06N 3/092

(57) ABSTRACT

A computer implemented method for configuring a reinforcement learning agent to perform an efficient reinforcement learning procedure, wherein the reinforcement learning agent comprises a model trained using a machine learning process to determine actions to be performed by the reinforcement learning agent. The method comprises using the model to determine an action to perform, based on values of a set of features obtained in an environment; determining, for a first feature in the set of features, a first indication of a relative contribution of the first feature, compared to other features in the set of features, to the determination of the action by the model; and determining a reward to be given to the reinforcement learning agent in response to performing the action, based on the first feature and the first indication.

### TECHNICAL FIELD

This disclosure relates to methods for configuring a reinforcement learning agent. More particularly but non-exclusively, the disclosure relates to configuring a reinforcement learning agent operating on a node in a communications network.

### BACKGROUND

In reinforcement learning (RL), a learning agent interacts with an environment and performs actions through a trial-and-error process in order to maximize a numerical reward.

A reward function plays an important role in a reinforcement learning (RL) system. It guides the system to operate in a desired manner by evaluating the actions of the RL agent and providing feedback (in the form of a reward) to the agent according to the effects of actions performed by the RL agent on the environment.

However, typically in the first stages of training a RL model, actions are performed randomly e.g. by trial and error, without the model being able to make reasonable estimations of how good certain actions are and what rewards will be achieved in different situations. The trial and error, or “exploration” phase is usually exhaustive with respect to time and efficiency if the agent works in a highly-varying condition (i.e. a huge state space leads to a long train time of the model).

RL systems such as Deep-Q-Networks (DQN) employ Deep Neural Networks (DNN) to select the best action to perform in order to obtain the best reward for the given state. Models that combine RL and DNN are also known as Deep RL. Deep RL is described in the paper entitled “Human-level control through deep reinforcement learning” by Mnih et al. (2015) Nature, vol. 518.

### SUMMARY

Despite the popularity of Deep RL due to its applicability for a variety of problems, it is prone to low interpretability due to the DNN model, which acts in a black-box manner that makes it hard to understand its behavior. Understanding the RL behavior is important to ensure that the agent's reward function is correctly modelled. However, in general, the reward function has to be set by manually observing the agent's behavior in the environment due to the aforementioned interpretability issue. Therefore, RL parameter tuning (specially the reward function) requires human intervention, which is a time-consuming and often difficult process.

It is an object of the disclosure herein to improve the interpretability and training of reinforcement learning agents that employ machine learning models such as DNNs to predict actions.

According to a first aspect there is a computer implemented method for configuring a reinforcement learning agent to perform an efficient reinforcement learning procedure, wherein the reinforcement learning agent comprises a model trained using a machine learning process to determine actions to be performed by the reinforcement learning agent. The method comprises using the model to determine an action to perform, based on values of a set of features obtained in an environment; determining, for a first feature in the set of features, a first indication of a relative contribution of the first feature, compared to other features in the set of features, to the determination of the action by the model; and determining a reward to be given to the reinforcement learning agent in response to performing the action, based on the first feature and the first indication.

According to a second aspect there is a node in a communications network for configuring a reinforcement learning agent to perform an efficient reinforcement learning procedure, wherein the reinforcement learning agent comprises a model trained using a machine learning process to determine actions to be performed by the reinforcement learning agent. The node is adapted to: use the model to determine an action to perform, based on values of a set of features in an environment; determine, for a first feature in the set of features, a first indication of a relative contribution of the first feature, compared to other features in the set of features, in the determination of the action by the model; and determine a reward to be given to the reinforcement learning agent in response to performing the action, based on the first feature and the first indication.

According to a third aspect there is an apparatus for configuring a reinforcement learning agent to perform an efficient reinforcement learning procedure wherein the reinforcement learning agent comprises a model trained using a machine learning process to determine actions to be performed by the reinforcement learning agent. The apparatus comprises: a memory comprising instruction data representing a set of instructions; and a processor configured to communicate with the memory and to execute the set of instructions. The set of instructions, when executed by the processor, cause the processor to: use the model to determine an action to perform, based on values of a set of features obtained in an environment; determine, for a first feature in the set of features, a first indication of a relative contribution of the first feature, compared to other features in the set of features, to the determination of the action by the model; and determine a reward to be given to the reinforcement learning agent in response to performing the action, based on the first feature and the first indication.

According to a fourth aspect there is a computer program comprising instructions which, when executed on at least one processor, cause the at least one processor to carry out the method of the first aspect.

According to a fifth aspect there is a carrier containing a computer program according to the fourth aspect, wherein the carrier comprises one of an electronic signal, optical signal, radio signal or computer readable storage medium.

According to a sixth aspect there us a computer program product comprising non transitory computer readable media having stored thereon a computer program of the fourth aspect.

In this way a RL Reward Function may be enhanced by identifying the contribution/influence that different input features have on the output of the machine learning model, and rewarding the agent accordingly. Thus, in systems like DQN, the reward function may be modified so as to encourage correct decision making based on the correct features. Similarly, decision making based on incorrect features may be discouraged. Correct decision making based on incorrect features (e.g. “false-positives”) may also be penalised. In this way the training may be improved, resulting in a more robust model.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 shows an example node in a communications network according to some embodiments herein;

FIG. 2 shows an example method according to some embodiments herein;

FIG. 3 shows an example method according to some embodiments herein;

FIG. 4 shows an example signal diagram according to some embodiments herein;

FIG. 5 shows an example application of the methods herein to antenna tilts;

FIG. 6 shows an example application of the methods herein to a moveable robot or autonomous vehicle;

FIG. 7 illustrates a set of features for use by a moveable robot or autonomous vehicle; and

FIG. 8 shows example feature importance values of the set of features in FIG. 7.

### DETAILED DESCRIPTION

The disclosure herein relates to efficient training of a reinforcement learning agent that employs a model trained using a machine learning process to predict the actions that should be performed by the machine learning agent (e.g. deep-reinforcement learning, DRL, or deep Q learning, DQL). Some embodiments herein relate to efficient training of such a reinforcement learning agent in a communications network (or telecommunications network).

A communications network may comprise any one, or any combination of: a wired link (e.g. ASDL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, 5G or subsequent standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

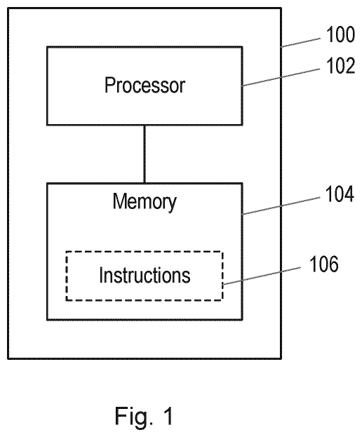

FIG. 1 illustrates a network node 100 in a communications network according to some embodiments herein. Generally, the node 100 may comprise any component or network function (e.g. any hardware or software module) in the communications network suitable for performing the functions described herein. For example, a node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network. Examples of nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC).

The node 100 is configured (e.g. adapted, operative, or programmed) to perform any of the embodiments of the method 200 as described below. It will be appreciated that the node 100 may comprise one or more virtual machines running different software and/or processes. The node 100 may therefore comprise one or more servers, switches and/or storage devices and/or may comprise cloud computing infrastructure or infrastructure configured to perform in a distributed manner, that runs the software and/or processes.

The node 100 may comprise a processor (e.g. processing circuitry or logic) 102. The processor 102 may control the operation of the node 100 in the manner described herein. The processor 102 can comprise one or more processors, processing units, multi-core processors or modules that are configured or programmed to control the node 100 in the manner described herein. In particular implementations, the processor 102 can comprise a plurality of software and/or hardware modules that are each configured to perform, or are for performing, individual or multiple steps of the functionality of the node 100 as described herein.

The node 100 may comprise a memory 104. In some embodiments, the memory 104 of the node 100 can be configured to store program code or instruction data 106 representing a set of instructions that can be executed by the processor 102 of the node 100 to perform the functionality described herein. Alternatively or in addition, the memory 104 of the node 100, can be configured to store any requests, resources, information, data, signals, or similar that are described herein. The processor 102 of the node 100 may be configured to control the memory 104 of the node 100 to store any requests, resources, information, data, signals, or similar that are described herein.

It will be appreciated that the node 100 may comprise other components in addition or alternatively to those indicated in FIG. 1. For example, in some embodiments, the node 100 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 102 of node 100 may be configured to control such a communications interface to transmit to and/or receive from other nodes or network functions requests, resources, information, data, signals, or similar.

Briefly, in one embodiment, the node 100 is configured to: use the model to determine an action to perform, based on values of a set of features in an environment; determine, for a first feature in the set of features, a first indication of a relative contribution of the first feature, compared to other features in the set of features, in the determination of the action by the model; and determine a reward to be given to the reinforcement learning agent in response to performing the action, based on the first feature and the first indication.

As described above, models trained using a machine learning process, such as neural networks, often appear to act as “black boxes” making it hard to determine how the inputs were processed or why the particular output was determined. By determining the impact or contribution each input feature had to the decision of the model when choosing an action, the reward received may be tweaked so as to reward good decision making (e.g. correct actions based on consideration of the correct e.g. causally linked input parameters) and penalise poor decision making (e.g. correct action for the wrong reason, or wrong action for the wrong reason). In this way the decisions made by the agent as to which actions to perform can be improved.

Although the disclosure is generally described in terms of a communications network, it will be appreciated that the methods herein may more generally be performed by any computer implemented apparatus. For example, an apparatus for configuring a reinforcement learning agent to perform an efficient reinforcement learning procedure as described herein may generally comprise a memory comprising instruction data representing a set of instructions; and a processor configured to communicate with the memory and to execute the set of instructions. The set of instructions, when executed by the processor, cause the processor to perform any of the methods described herein, such as the method 200 or the method 300, described below. Processors, memories and instruction data were all described above with respect to the node 100 and the detail therein will be understood to apply equally to such computer implemented apparatus.

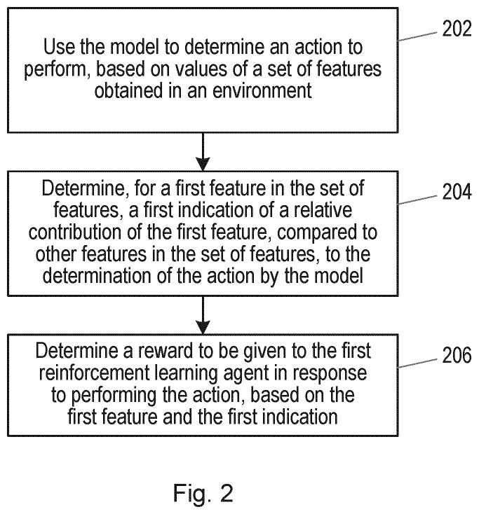

Turning now to FIG. 2, there is a computer implemented method for configuring a reinforcement learning agent to perform an efficient reinforcement learning procedure, wherein the reinforcement learning agent comprises a model trained using a machine learning process to determine actions to be performed by the reinforcement learning agent. In brief, the method comprises in a first step using 202 the model to determine an action to perform, based on values of a set of features obtained in an environment. In a second step the method 200 comprises determining 204, for a first feature in the set of features, a first indication of a relative contribution of the first feature, compared to other features in the set of features, to the determination of the action by the model, and in a third step the method comprises determining 206 a reward to be given to the reinforcement learning agent in response to performing the action, based on the first feature and the first indication.

The skilled person will be familiar with reinforcement learning and reinforcement learning agents, however, briefly, reinforcement learning is a type of machine learning process whereby a reinforcement learning agent (e.g. algorithm) is used to perform actions on a system (such as a communications network) to adjust the system according to an objective (which may, for example, comprise moving the system towards an optimal or preferred state of the system). The reinforcement learning agent receives a reward based on whether the action changes the system in compliance with the objective (e.g. towards the preferred state), or against the objective (e.g. further away from the preferred state). The reinforcement learning agent therefore adjusts parameters in the system with the goal of maximising the rewards received.

Put more formally, a reinforcement learning agent receives an observation from an environment in state S and selects an action to maximize the expected future reward r. Based on the expected future rewards, a value function V for each state can be calculated and an optimal policy π that maximizes the long term value function can be derived.

In the context of this disclosure, in some embodiments herein, the method is performed by a node in a communications network and the set of features are obtained by the communications network. For example, the reinforcement learning agent may be configured for improved control or adjustment (e.g. optimisation) of operational parameters of the communications network, such as configuration parameters of network processes, hardware and/or software. These embodiments enable the reinforcement learning agent to suggest changes to operational parameters of communications network in a reliable, resource efficient manner, whilst ensuring that its decisions are based on appropriate input features. In such embodiments, the “environment” may comprise e.g. the network conditions in the communications network, the conditions in which the communications network is operating and/or the conditions in which devices connected to the communications network are operating. At any point in time, the communications network is in a state S. The “observations” comprise values relating to the process in the communications network that is being managed by the reinforcement learning agent (e.g. KPIs, sensor readings etc) and the “actions” performed by the reinforcement learning agents are the adjustments made by the reinforcement learning agent that affect the process that is managed by the reinforcement learning agent.

In some examples, the reinforcement learning agent is for determining a tilt angle for an antenna in the communications network. In such examples, the set of features may comprise, for example, signal quality, signal coverage and a current tilt angle of the antenna. The action comprises an adjustment to the current tilt angle of the antenna (e.g. adjust tilt up, adjust tilt down), and the reward is based on a change in one or more key performance indicators related to the antenna, as a result of changing the tilt angle of the antenna according to the adjustment.

In other examples, the reinforcement learning agent is for determining motions of a moveable robot or autonomous vehicle. In such embodiments, the environment may be the physical environment in which the robot or vehicle operates, e.g. including the proximity of the robot/vehicle to other objects or people, as well as any other sensory feedback obtained by the robot.

Generally, the reinforcement learning agents herein receive feedback in the form of a reward or credit assignment every time they perform an adjustment (e.g. action). Rewards may be positive (e.g. providing positive feedback) or negative (e.g. penalising or providing negative feedback to the agent). Rewards may be assigned based on a reward function that describes the rewards that are given for different outcomes. As noted above, the goal of the reinforcement learning agents herein is to maximise the reward received.

When a RL agent is deployed, the RL agent performs a mixture of “random” actions that explore an action space and known (e.g. previously tried) actions that exploit knowledge gained by the RL agent thus far. Performing random actions is generally referred to as “exploration” whereas performing known actions (e.g. actions that have already been tried that have a more predictable result) is generally referred to as “exploitation” as previously learned actions are exploited.

The reinforcement learning agents herein use models trained by a machine learning process (which may alternatively be described herein as “machine learning models”) when predicting an action to perform. For example, in some embodiments, the reinforcement learning agent employs Q-learning and uses a deep neural network (DNN) to predict an action to perform. In other words, in some embodiments the reinforcement learning agent may comprise a deep-Q learning agent. In this example, a reinforcement learning agent uses a neural network to predict the Q values (e.g. relative likelihood of receiving a positive reward, or the quality of each action given the current state of the environment) associated with different actions that could be performed given the current state of the environment.

This model is the central operation of the RL behavior. The goal of DQN in RL is to train the DNN model to predict the correct (e.g. optimal) action with high accuracy.

This is an example however and the skilled person will appreciate that the principles described herein may equally be applied to other reinforcement learning agents that employ other learning schemes to Q-learning, and/or other machine learning models used to predict appropriate actions for a reinforcement learning agent. For example, a random forest algorithm may alternatively be used in place of a neural network in the deep Q-learning example above.

In step 202 the reinforcement agent uses the model (e.g. in DQN embodiments, the neural network model) to determine an action to perform, based on values of a set of features obtained in an environment.

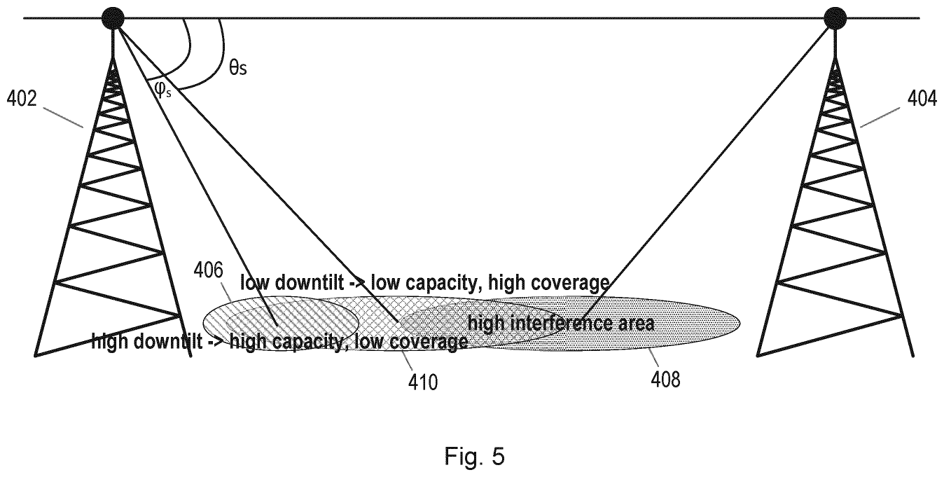

The set of features will vary according to the environment and the task being performed by the reinforcement learning agent. Where the reinforcement learning agent operates in a communications network, the set of features may comprise, for example, KPI values or other metrics in the communications system (load, latency, throughput, etc). Other examples are discussed in detail below with respect to FIGS. 5, 6 and 7.

The values of the set of features describe/reflect the current state of the environment, s. The model takes the state s. In embodiments where the reinforcement learning agent comprises a Q learning agent, the model may output a Q value for each possible action that the reinforcement learning agent may make, given the state s. The Q values represent an estimate for the expected future reward from taking an action a in state s. More generally, the model may output an indication of the relative likelihood of receiving a positive reward for each possible action.

Based on the output of the model, the agent then selects an action to perform. For example, in Q learning, in exploitation, the action with the highest Q value may be selected as the appropriate action (in exploration, other actions may be taken, for example, at random).

In step 204, the method comprises determining, for a first feature in the set of features, a first indication of a relative contribution of the first feature, compared to other features in the set of features, to the determination of the action by the model.

In this sense, the relative contribution may be the influence that the first feature had on the model when determining an action to be performed. For example, in a Q-learning example, the influence that the first feature had on the model when determining a Q value for the action.

In some embodiments the features may be ranked according to contribution, for example, from most influencing feature to least influencing feature. In some embodiments, the relative contributions may be quantified, for example, on a normalised scale.

In this way, the output of step 204 may give insights into why a particular action was chosen by the agent, by indicating which features contributed most strongly to the decision.

In some embodiments the step of determining 204 the first indication of the relative importance of the first feature is performed using an explainable artificial intelligence, XAI, process. The skilled person will be familiar with XAI, but in brief, in order to understand a black box model, an XAI method performs tests to extract the model characteristics. For example, XAI methods may perturb the input data to analyze model behaviour. The most common output generated by this method is feature importance. Feature importance shows how important a feature is to generate an output/prediction. In other words, it shows how much a feature contributed to generating the output of the model. Generally, in XAI the inputs are: data input to the model, the model, and the prediction of the model. The output is the explanation e.g. information describing how the model determined its prediction from the data input to it. Feature importance is one example output of an XAI process.

Generally, there are many XAI methods that may be used in the methods herein, including but not limited to, reward decomposition, minimal sufficient explanations and structural causal models. Example XAI methods are described in the paper by Puiutta & Veith (2020) entitled: “Explainable Reinforcement Learning: A Survey”. arXiv:2005.06247 May 2020.

Generally, following step 204, the determined action may be performed and the new state, s′ may be determined by determining new values of the set of parameters.

In step 206 the method then comprises determining a reward to be given to the reinforcement learning agent in response to performing the action, based on the first feature and the first indication.

Ordinarily, in RL a reward is allocated for an action according to a reward function. In embodiments herein, the rewards allocated from a reward function may be modified using the first feature and the first indication. For example, the (standard) reward stipulated in the reward function may be adjusted (or scaled) dependent on whether the correct features contributed to the decision to recommend the particular action.

Thus, in some embodiments, the measures of contribution or feature importance as output from XAI, are used herein to modify the rewards given to the reinforcement learning agent. In other words, embodiments herein perform reward modelling or reward shaping based on feature importance values output by an XAI process. This strategy guides the training process of the RL model to always ‘pay attention to’ (e.g. make decisions based on) the most important feature(s).

To this end, generally, the RL agent may be penalised for making a decision based on incorrect, or less relevant features and rewarded (or further rewarded) for making a decision based on correct, or more relevant features.

There are various ways that can be used to determine whether the first feature is a correct or incorrect feature with which to have determined the action:

Human/operator feedback may be used to determine whether a feature is a correct/incorrect feature with which to have made the decision. For example, a human may evaluate a feature importance output and check if it matches the action taken by the RL.

Specific features may be defined upfront that should be prioritized. For example, the feature (or features) that should present as relevant/important may be predetermined. The reward may then be directly adjusted according to the first indication (e.g. which may be a feature importance output as above).

Adding a predefined-function to identify the most important feature. A function that receives feature importance as input and returns how this value reflects the current scenario. For instance, in a mobile robot or autonomous vehicle use case, a pre-defined function may check that a feature corresponding to the distance to the nearest obstacle is always the most strongly contributing feature to the decision, in order to prevent a collision.

For example, in some embodiments, the step of determining 206 a reward comprises penalising the reinforcement learning agent if the first indication indicates that the first feature most strongly contributed to the determination of the action by the model and the first feature is an incorrect feature with which to have determined the action. In other words, the method may comprise determining the most strongly contributing feature and penalising the reinforcement learning agent if the most strongly contributing feature is an inappropriate feature with which to have determined the action. In this way a RL agent can be penalised for making a decision based on an incorrect feature.

In some embodiments, the step of determining 206 a reward comprises rewarding the first reinforcement learning agent if the first indication indicates that the first feature most strongly contributed to the determination of the action by the second model and the first feature is a correct feature with which to have determined the action. In other words, the method may comprise determining the most strongly contributing feature and rewarding the reinforcement learning agent if the most strongly contributing feature is an appropriate or correct feature with which to have determined the action. In this way a RL agent can be rewarded (or further rewarded) for making a decision based on a correct feature.

In some embodiments, the step of determining a reward comprises penalising the reinforcement learning agent if the first indication indicates that the first feature least strongly contributed to the determination of the action by the model and the first feature is a correct feature with which to have determined the action. In other words, the method may comprise determining the least strongly contributing feature and penalising the reinforcement learning agent if this feature should have been considered when determining the action. In this way, a RL agent can be penalised for not taking into account features that should have been taken into account.

As noted above, in some embodiments, the step of determining a reward comprises modifying (reward) values in a reward function based on the action, the first feature and the first indication. In this way, reward modelling or reward shaping may be used to produce a dynamic reward value (instead of static reward value) based on whether the model used the correct features to determine the appropriate action.

Generally step 206 may comprise determining the most strongly contributing feature and adjusting the value of the reward based on the most strongly contributing feature(s). The value of the reward may be modified by a predetermined increment, for example, +/−0.1. The skilled person will appreciate that the magnitude of the predetermined increment will depend on the particular application. Alternatively, a scaling may be applied to the reward value, so as to increase or decrease the reward factor based on the most strongly contributing feature(s). The scaling factor for the punishment can be adjusted according to the scale of the deviation (e.g. the further it is from the actual important feature; the higher punishment is given).

Generally, the reward values in the reward function may be modified or adjusted by decreasing the respective reward in the reward function by a predetermined increment in the following circumstances:
i) The wrong action is performed for the right reason/based on the correct feature. In other words, if the action is an incorrect action but the first indication indicates that the first feature contributed most strongly to the determination of the action by the model and the first feature is a correct feature with which to have determined the action. In this case, the reward may be scaled so as to increase the negative reward.
ii) The correct action was chosen, but for the wrong reason/based on the wrong feature: In other words, if the action is a correct action but the first indication indicates that the first feature contributed most strongly to the determination of the action by the model and the first feature is an incorrect feature with which to have determined the action. In this case the reward may be scaled so as to reduce the positive reward (which would otherwise be given for making a correct action).
   The technical effect of this is that “false positive” or accidentally correct actions are discouraged, so that the model is encouraged to make correct decisions based on the correct features. This improves the robustness of the model by detecting false positives that would otherwise be undetectable due to the black box nature of machine models such as NNs. Another advantage of this is that it prevents the model from converging during training on a solution that only predicts the correct actions in a limited range of circumstances, but breaks down, e.g. in edge cases due to the fact that the model is actually predicting actions based on the wrong features. This could occur, for example, if a model had converged on a local minima in a gradient descent algorithm rather than a global minimum, due to lack of training, training having been performed on a non-representative dataset, or even a problem in the DQN architecture. Thus, the methods described herein can help reduce false-positives caused by such problems.
iii) The wrong action was chosen for the wrong reason/based on the wrong feature: In other words if the action is an incorrect action and the first indication indicates that the first feature contributed most strongly to the determination of the action by the model and the first feature is an incorrect feature with which to have determined the action.

It will be appreciated that the reward may be adjusted by different amounts in the three scenarios above. For example, the reward may be decreased more in scenario iii) than scenario i), as in scenario i) the correct features were considered, even if the outcome was incorrect, however in scenario iii) incorrect features were used and the outcome was also incorrect.

In some embodiments, the reward may be unmodified (or even increased), if the right action is performed for the right reason. For example, if the action is a correct action and the first indication indicates that the first feature contributed most strongly to the determination of the action by the model and the first feature is a correct feature with which to have determined the action. In this way, rewards are given for correct decisions performed on the basis of the correct features.

In some embodiments, the reward may be determined based on more than one feature. For example, the method may comprise determining, for a second feature in the set of features, a second indication of a relative importance of the second feature, compared to other features in the set of features, in the determination of the action by the second model, and the step of determining 206 a reward to be given to the first reinforcement learning agent in response to performing the action may be further based on the second feature and the second indication.

As an example, the first feature may be the most strongly contributing feature and the second feature may be the second most strongly contributing feature. This is merely an example however and the skilled person will appreciate that any combination of features may be considered. Furthermore step 206 is not limited to only two features, rather the relative contributions of any number of features may be considered when determining the reward or adjusting the reward given to the agent.

Once the reward is determined, the method may further comprise obtaining updated values of the set of features after the action is performed (e.g. the updated state s). The values of the set of features, s, the determined action, a, the determined reward, r, and the updated values of the set of features, s′, may then be used as training data to further train the model. The model (e.g. NN) may be trained using the <s, a, r, s′> data in the normal way (e.g. using methods such as gradient descent, or back propagation).

An noted above, the goal of DQN in RL is to train the DNN model to predict the correct (e.g. optimal) action with high accuracy. However, the black box nature of DNNs make it hard to understand the rationale behind every decision. Herein, as described above, explainability methods are used to explain the characteristics of black box model and model the reward function accordingly. The advantages of the method described above are the improvement of reward function calculation, and improved adaptability of the reward function. The system's characteristics are explainable and understandable. The training process is sped up (more efficient training). It increases the level of autonomy where the feedback from human can be delegated to the explainability method. The method also reduces the search space of the RL exploration, which is especially relevant when training needs to be executed in the edge, e.g. for real time execution.

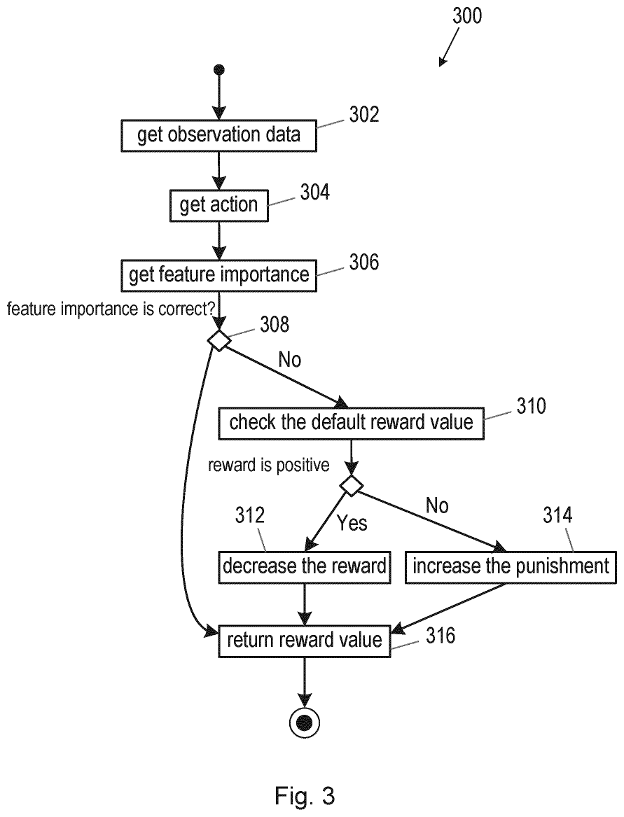

Turning now to FIG. 3 which shows an embodiment of the method 200 according to an example. As described above, this example method is for configuring a reinforcement learning agent to perform an efficient reinforcement learning procedure. The reinforcement learning agent comprises a model trained using a machine learning process to determine actions to be performed by the reinforcement learning agent. The reinforcement learning agent may be configured to perform any of the tasks described above.

In this embodiment, in step 302 values of a set of features in the environment are obtained in the form of observation data.

In step 304, step 202 is performed, as described above, and a model such as a NN model is used by a RL agent to determine an action to perform, based on the values of a set of the features obtained in 302.

At 306, step 204 is performed, as described above, and feature importance values are determined for one or more of the features, indicating the relative contribution that each feature made to the determination of the action by the model.

Step 206, described above is then performed according to the logic in blocks 308, 310, 312, 314, 316 which are used in combination to determine a reward to be given to the reinforcement learning agent in response to performing the action.

At 308, it is determined whether the feature importance is correct, e.g. whether the most strongly contributing feature(s) are the correct features with which to have determined the action to take.

If the features are correct, then at 316, an unmodified reward value taken from the reward function is given in 316.

If the feature importance values are incorrect, then at 310, the default (unmodified) reward value is determined from the reward function.

If the (default) reward is positive, then at 312, the value of the reward in the reward function is decreased (for example, by means of an incremental decrease or scaling factor as described above) and returned in block 316.

If the (default) reward is negative, then at 314, the value of the reward in the reward function is decreased further and returned in block 316.

Thereby, according to the steps above, reward values in a reward function may be dynamically modified to take into account whether the correct features were used by the model to determine an action to take. In the example of FIG. 3, if the important feature is correct the default reward value is used, while if it is incorrect, additional punishment is given by decreasing the reward.

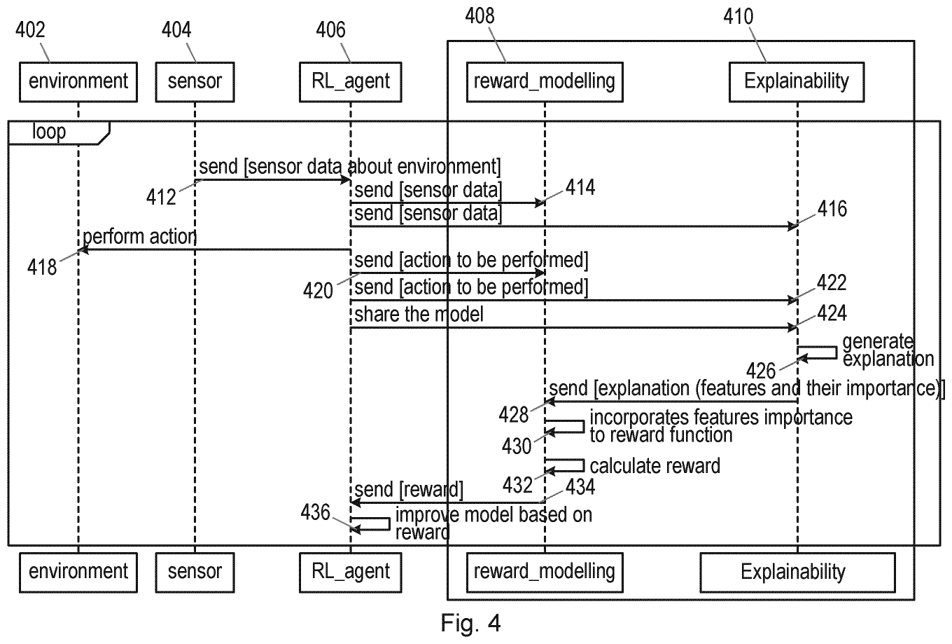

Turning now to FIG. 4 which shows a signalling diagram that may be used to implement the example shown in FIG. 3 in a communications network. In this example the method 300 is performed in a communications network environment 402. The reinforcement learning agent may be configured to determine actions to be performed in or via the communications network, for example, determining an antenna tile (as described in more detail below with respect to FIG. 5), or more generally for adjusting or optimising operation parameters in the communications network.

In this embodiment, the set of features comprise sensor readings from sensors 404, as such, the sensor readings represent observations of the state, s, of the environment. There is also a reinforcement learning agent 406 that implements DQN and uses a NN model to determine which actions to perform. There is also a “Reward Modelling Module 408 and an Explainability module 410. It will be appreciated however that these modules are examples only and that the functionality described here may also be split between other modules to those illustrated in FIG. 4. In this example, the following steps are performed:

Step 412: Sensor data from the environment is obtained and sent from sensors 404 to the RL agent 404.

Steps 414 and 416: The sensor data is sent to the reward modelling module 408 and the explainability module 410.

Step 418: With this information, the RL agent performs step 204 described above and uses the NN to determine an action to perform in the communications network, based on the values of the sensor data (i.e. the set of features). The action is selected based on the policy that is applied to it and the RL agent performs the determined action. The action affects the environment.

Steps 420 and 422: The chosen action is then sent to both the reward modelling and explainability modules 408, 410.

Step 424: A copy of the NN that is used in the RL agent is also sent to the explainability module 410.

Step 426: The explainability module performs step 204. XAI is used, taking the sensor data, the RL model, and the selected action as the input. The XAI provides as output an indication of a relative contribution of one or more features, in the form of feature importance values to the model when determining the action (e.g. feature importance values for one or more sensor readings). Any post-hoc XAI method can be used to generate local explanation (in the form of feature importance).

Step 428: The feature importance values are then sent to the reward modelling module.

Steps 430 and 432: The reward modelling module performs step 206 whereby the feature importance information is used adjust the reward given to the RL agent for the action. In this embodiment a scaling is calculated based on whether the feature is a correct feature with which to have determined the action and the normal reward modelling is then multiplied by the scaling value.

Step 434: The scaled reward value is then sent to the RL agent.

Step 436: the RL agent uses this reward value to improve/further train the NN model.

Turning now to other embodiments, as noted above, the methods described herein may be applied to determining an appropriate tilt angle for an antenna in a communications network. In the antenna tilt problem, adjusting the tilt of the antenna determines the coverage and the quality of the signal. Generally, it is desirable for the model to focus on the lower performing metrics (coverage vs quality) when taking the decision. A misconfiguration could create disruption to network users.

Thus the methods herein (such as the methods 200 and/or 300) may be performed by a node in a communications network where the reinforcement learning agent is for use in determining a tilt angle for an antenna in the communications network. For example, the set of features may comprise signal quality, signal coverage and a current tilt angle of the antenna. The action may comprise an adjustment to the current tilt angle of the antenna and the reward may be further based on a change in one or more key performance indicators related to the antenna, as a result of changing the tilt angle of the antenna according to the adjustment.

FIG. 5 shows an embodiment whereby the method 200 is performed by a node in a communications network (such as the node 402 or 404, although it will be appreciated that the method may be performed by any node in the communications network, including physical nodes, distributed nodes or nodes in the cloud) to determine (e.g. optimise) the antenna tilt.

In this embodiment, the reinforcement learning agent is for use in determining a tilt angle for an antenna in the communications network, as an example, the reinforcement learning agent may determine/optimise values of the angles cp s and e s as shown in FIG. 5. A set of features are obtained by the communications network, comprising, for example, signal quality, signal coverage, antenna-tilt angle, network capacity, signal power and interference levels. Other features may also be used, for example, other KPIs associated with the nodes, such as load or time of day. Values of the features are provided to a RL agent as input and the RL agent uses a DQN to determine appropriate actions to perform. The actions may be in the form of a recommended tilt angle. The feature values are thus provided to a NN in the RL agent, as the inputs to the NN model. The NN is used to determine an action to perform. In this example the agent may choose between actions such as tilting-up, not-tilting, or tilting-down the antenna. The reward depends on the improvement of a set of KPIs (AKPI). The set of KPIs that are used to determine the reward may comprise, for example: Coverage: e.g. whether an action results in an area of interest being covered with a minimum level of Reference Signal Received Power (RSRP); Capacity: the number of UEs that the cell can handle simultaneously; and Quality: effect of negative interference from neighboring cells.

As can be seen in FIG. 5, generally, low down tilt results in a low capacity, high coverage area, whilst a high down tilt results in a high capacity, low coverage area. Interference from neighbouring base stations 404 may also be taken into consideration. If the current KPI values are the same or greater than the previous, the agent will get a positive reward. Otherwise, (i.e. the KPI value decreases), the agent will get a ‘punishment’ (negative reward).

The most important feature is the one that most strongly contributes to produce the agent action. Table 1 in Appendix 1 below shows the most important feature for different states and actions determined by the agent. The relationship between the action and the most strongly contributing feature is used to understand whether the decision taken by the agent was correct (see “Indicates” column of Table 1). For example, if the current state has low coverage and good quality measure (case 2.A in Table 1), the focus of the model is to improve the coverage of the antenna. The other possible observation that may occur is presented in Table 1 below. Generally, this may be constructed as a joint optimisation problem, and the correct features with which to predict the action may be a function of the network conditions, the type of users and/or the antenna type.

From these interpretations (i.e. “Indicates” column), the reward function is fine-tuned in an automated manner. In situations that the agent produced the correct action, the reward function remains the same. Otherwise, the reward function may be scaled accordingly as shown in the last column of the Table 1.

In this way, a reinforcement learning agent can be trained to suggest antenna tilt angles in a reliable, resource efficient manner, using a model such as a NN, whilst ensuring that the NN bases its decisions on appropriate input features. It will be appreciated that the details above are merely an example, however. For example, different inputs may be provided to those described above, different KPIs may be used in the reward function and the reward function may be set up in a different manner to that described above.

Turning now to other embodiments, generally the methods herein (such as the methods 200 and/or 300 described above) may be used to determine movements of a mobile robot or autonomous vehicle. In a robotics application, safety is an important part of the operation. A robot collision is considered an incident and it has the potential to harm any humans that are involved and/or damage other equipment. In some cases, it may also jam the production process that can lead to a loss. Reducing such risk can be seen as an obstacle-avoidance problem. The robot must not collide with any object especially the one which is the closest to the robot.

Generally a mobile robot or autonomous vehicle may be connected to, and receive instructions through a communications network, in which case the methods herein (such as the method 200 and/or 300) may be performed by a node in the communications network. In other examples, the methods herein (such as the methods 200 or 300) may be performed by the mobile robot or autonomous vehicle itself, e.g. the RL agent may operate on board the robot/vehicle.

In such examples, generally, the set of features comprise sensor data from the mobile robot related to distances between the mobile robot and other objects surrounding the mobile robot. The action comprises sending an instruction to the mobile robot to instruct the mobile robot to perform a movement or a change in motion, and the reward is based on the changes to the distances between the mobile robot and other objects surrounding the mobile robot as a result of the mobile robot performing the movement.

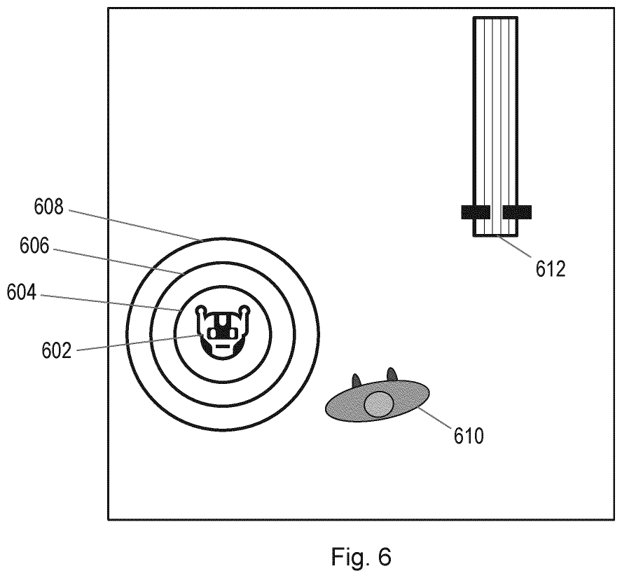

FIG. 6 illustrates an example embodiment relating to a mobile robot 602. In this embodiment, a Deep RL technique is used to provide safety for human-robot collaboration (HRC) (where humans and mobile robots perform collaborative tasks and share the same workspace without any boundaries). In FIG. 6, a robot 602 operates in an environment with a human 610 and a conveyor belt 612. In order to prevent a collision whilst allowing the robot 602 to move around the environment, different safety zones are used. These are represented as the circles 604/critical, 606/warning, and 608/safe around the robot 602. The presence or absence of an object in the circular safety zones is used to determine the reward given to the RL agent following a movement. In this embodiment, the input/observations to the RL agent are the condition of the obstacle in front of the robot.

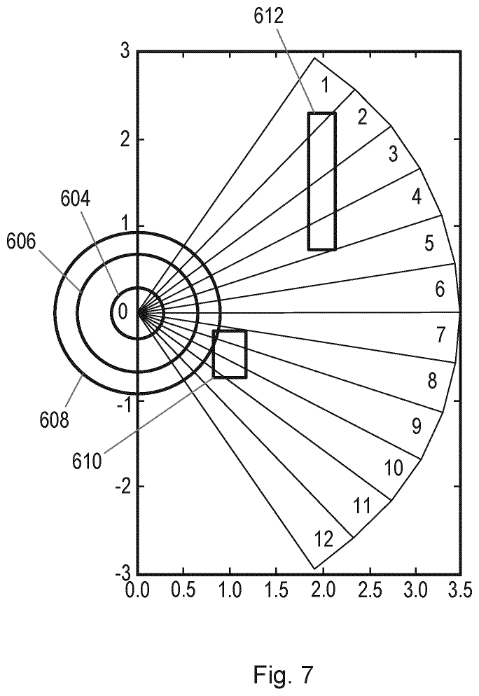

As an example, the observation state may be divided into different triangular “observation” zones, as shown in FIG. 7 which shows the position of the robot at position 0, the same circular safety zones as shown in FIG. 6, and triangular observation zones 612. In this example, following each action, the distance to the nearest obstacle is measured in each observation zone. The distances to the nearest object in each zone comprise the set of features that are provided to a DQN model to generate the next agent (e.g. robot/vehicle) action. FIG. 7 thus illustrates the state formulation of the RL problem wherein the input is the distance of nearest obstacle from twelve different zone in front of the robot.

In this example, a reward function may be modeled based on the robot's current state and nearest obstacle position as follows:
If a collision happens: −10
If there is an obstacle in critical zone: −5
If there is an obstacle in warning zone: −1
If the robot has travelled for >0.5 meters: +10
None of the above: −0.05

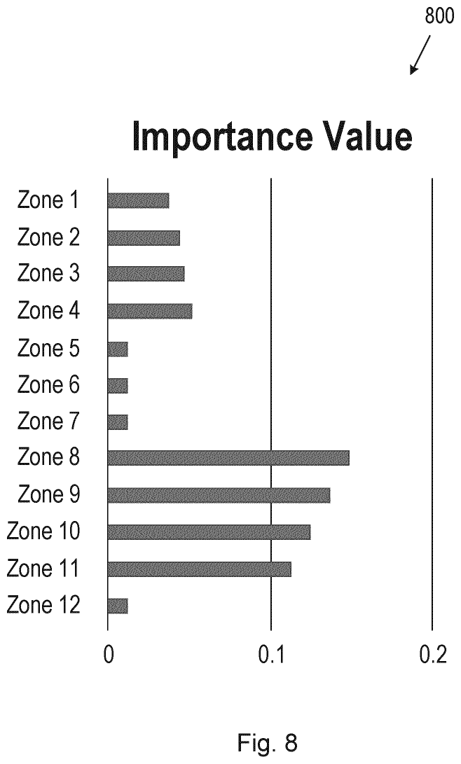

Example feature importance values of each feature from the given example, determined using XAI is illustrated in FIG. 8. To exemplify, FIG. 7 shows the human detected as the closest obstacle. In the RL state representation, zone 8 (as shown in FIG. 8) should have the lowest distance value to the obstacle. If the explanation shows that the DQN agent takes a certain action (e.g. stopping the robot) because of zone 8, it means the agent has made a decision based on the correct feature. Table 2 of Appendix 2 illustrates some different scenarios for the example shown in FIGS. 7 and 8.

In the enhanced reward function herein, a good indication of the working model would maintain the default reward value while indication of misconfiguration such as case B, C, and D would increase the punishment (negative reward).

By matching the RL action and the generated explanation (i.e. important feature), it is thus possible to derive conclusions about the agent behaviour as shown in the fourth column of Table 2. From that, the reward function can be adjusted according to this interpretation. Therefore, in case of a good actuation of the RL agent, the reward function will maintain unchanged. On the contrary, the reward function will be regulated to increase its punishment (e.g. increase negative reward) as in cases 1.B, 1.C, and 1.D.

In this way, the RL agent can be trained to make improved decisions based on the most relevant zones in order to prevent a collision. It will be appreciated that the detail herein is an example only, for example other zones e.g. more, or fewer zones of the same or different shape may be defined compared to those illustrated in FIG. 7. Furthermore, a different reward function may be defined, to that described above.

Turning now to other embodiments, there is provided a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

### APPENDIX 1

TABLE 1
Examples of different conditions/cases of the antenna tilt use case.

| | State/feature | | | | | | |
|---|---|---|---|---|---|---|---|
| | | | Tilt | | Important | | Reward |
| Case | Coverage | Quality | Angle | Action | Feature | Indicates | Scaling |
| 2.A | 50% | 95% | −20 | Tilt up | coverage | Good performance: the right | No change |
| | | | | | | action for the right reason | |
| 2.B | 50% | 90% | −40 | Tilt down | coverage | Model is suboptimal or | Increase |
| | | | | | | misconfiguration: the wrong | negative |
| | | | | | | action for the right reason | reward |
| 2.C | 50% | 90% | −40 | Tilt up | quality | Model is suboptimal or | Reduce |
| | | | | | | misconfiguration: the right | positive |
| | | | | | | action for the wrong reason | reward |
| 2.D | 50% | 90% | −40 | Tilt down | quality | Model is suboptimal or | Increase |
| | | | | | | misconfiguration: the wrong | negative |
| | | | | | | action for the wrong reason | reward |

### APPENDIX II

TABLE 2
Examples of different conditions/cases where
the feature importance indicates the behavior
of the model for the moveable robot use case.

| | | Important | | Reward |
|---|---|---|---|---|
| Case | Action | Feature | Indicates | scaling |
| 1.A | Stop | Zone 8 | Good performance: the right | No change |
| | | | action for the right reason | |
| 1.B | Speed | Zone 8 | Model is suboptimal or | Increase |
| | up | | misconfiguration: the wrong | negative |
| | | | action for the right reason | reward |
| 1.C | Stop | Zone 6 | Model is suboptimal or | Reduce |
| | | | misconfiguration: the right | positive |
| | | | action for the wrong reason | reward |
| 1.D | Speed | Zone 6 | Model is suboptimal or | Increase |
| | up | | misconfiguration: the wrong | negative |
| | | | action for the wrong reason | reward |

1. A computer implemented method for configuring a reinforcement learning agent to perform an efficient reinforcement learning procedure, wherein the reinforcement learning agent comprises a model trained using a machine learning process to determine actions to be performed by the reinforcement learning agent, the method comprising:
using the model to determine an action to perform, based on values of a set of features obtained in an environment;
determining, for a first feature in the set of features, a first indication of a relative contribution of the first feature, compared to other features in the set of features, to the determination of the action by the model; and
determining a reward to be given to the reinforcement learning agent in response to performing the action, based on the first feature and the first indication.

2. A method as in claim 1 wherein the step of determining a reward comprises:
penalising the reinforcement learning agent if the first indication indicates that the first feature most strongly contributed to the determination of the action by the model and the first feature is an incorrect feature with which to have determined the action.

3. A method as in claim 1 wherein the step of determining a reward comprises:
rewarding the reinforcement learning agent if the first indication indicates that the first feature most strongly contributed to the determination of the action by the model and the first feature is a correct feature with which to have determined the action.

4. A method as in claim 1 wherein the step of determining a reward comprises:
penalising the reinforcement learning agent if the first indication indicates that the first feature least strongly contributed to the determination of the action by the model and the first feature is a correct feature with which to have determined the action.

5. A method as in claim 1 wherein the step of determining a reward comprises:
modifying values in a reward function based on the action, the first feature and the first indication.

6. A method as in claim 5 wherein the values in the reward function are modified by:
decreasing the respective reward in the reward function by a predetermined increment if:
iv) the action is an incorrect action but the first indication indicates that the first feature contributed most strongly to the determination of the action by the model and the first feature is a correct feature with which to have determined the action;
v) the action is a correct action but the first indication indicates that the first feature contributed most strongly to the determination of the action by the model and the first feature is an incorrect feature with which to have determined the action; or
vi) the action is an incorrect action and the first indication indicates that the first feature contributed most strongly to the determination of the action by the model and the first feature is an incorrect feature with which to have determined the action.

7. A method as in claim 1, further comprising:
determining, for a second feature in the set of features, a second indication of a relative importance of the second feature, compared to other features in the set of features, in the determination of the action by the model; and
wherein the step of determining a reward to be given to the reinforcement learning agent in response to performing the action is further based on the second feature and the second indication.

8. A method as in claim 1 further comprising:
initiating the determined action.

9. A method as in claim 8 further comprising:
obtaining updated values of the set of features after the action is performed; and
using the values of the set of features, the determined action, the determined reward, and the updated values of the set of features as training data to train the model.

10. A method as in claim 1 wherein the method is performed by a node in a communications network and the set of features are obtained by the communications network.

11. A method as in claim 10 wherein the reinforcement learning agent is configured for adjustment of operational parameters of the communications network.

12. A method as in claim 10 wherein the reinforcement learning agent is for use in determining a tilt angle for an antenna in the communications network.

13. A method as in claim 12 wherein:
the set of features comprise signal quality, signal coverage and a current tilt angle of the antenna;
the action comprises an adjustment to the current tilt angle of the antenna; and
the reward is further based on a change in one or more key performance indicators related to the antenna, as a result of changing the tilt angle of the antenna according to the adjustment.

14. A method as in claim 10 wherein the method is for use in determining movements of a mobile robot or autonomous vehicle receiving instructions through the communications network.

15. A method as in claim 14 wherein:
the set of features comprise sensor data from the mobile robot related to distances between the mobile robot and other objects surrounding the mobile robot;
the action comprises sending an instruction to the mobile robot to instruct the mobile robot to perform a movement; and
the reward is based on the changes to the distances between the mobile robot and other objects surrounding the mobile robot, as a result of the mobile robot performing the movement.

16. A method as in claim 1 wherein the method is performed by a mobile robot or autonomous vehicle and wherein the reinforcement learning agent is for use in determining movements of the mobile robot or autonomous vehicle.

17. A method as in claim 1 wherein the step of determining the first indication of the relative importance of the first feature is performed using an explainable artificial intelligence, XAI, process.

18. A method as in claim 1 wherein the reinforcement learning agent is a deep reinforcement learning agent.

19. A method as in claim 1 wherein the model is a neural network, trained to take as input values of the set of features and output Q-values for possible actions that could be taken in the communications network.

20. (canceled)

21. (canceled)

22. An apparatus for configuring a reinforcement learning agent to perform an efficient reinforcement learning procedure, wherein the reinforcement learning agent comprises a model trained using a machine learning process to determine actions to be performed by the reinforcement learning agent, the apparatus comprising:
a memory comprising instruction data representing a set of instructions; and
a processor configured to communicate with the memory and to execute the set of instructions, wherein the set of instructions, when executed by the processor, cause the processor to:
use the model to determine an action to perform, based on values of a set of features obtained in an environment;
determine, for a first feature in the set of features, a first indication of a relative contribution of the first feature, compared to other features in the set of features, to the determination of the action by the model; and
determine a reward to be given to the reinforcement learning agent in response to performing the action, based on the first feature and the first indication.

23. (canceled)

24. (canceled)

25. (canceled)

26. (canceled)

27. (canceled)
